(19) United States
(12) Patent Application Publication
(10) Pub. No.: US 2016/0311019 A1
(43) Pub. Date: Oct. 27, 2016

(54) SOFT MAGNETIC POWDER MIX

(71) Applicant: HÖGANÄS AB (PUBL), Höganäs (SE)

(72) Inventors: Zhou YE, Lerberget (SE); Ann-Christin HELLSÉN, Höganäs (SE)

(73) Assignee: HÖGANÄS AB (PUBL), Höganäs (SE)

(21) Appl. No.: 15/105,952

(22) PCT Filed: Dec. 19, 2014
(86) PCT No.: PCT/EP2014/078836

§ 371 Date: Jun. 17, 2016

(30) Foreign Application Priority Data
Dec. 20, 2013 (EP) 13198896.6

(51) Int. Cl. B22F 1/02; B22F 3/16; H01F 41/02; H01F 1/24; H01F 3/08; B22F 1/00; B22F 5/00

(52) U.S. Cl. CPC B22F 1/02; B22F 1/0059; B22F 3/16; B22F 5/00; H01F 1/24; H01F 3/08; H01F 41/0246; B22F 2301/35; B22F 2998/10

(57) ABSTRACT

The present invention concerns a composite iron-based powder suitable for soft magnetic applications such as inductor cores. The present invention also concerns a method for producing a soft magnetic component and the component produced by the method.

### FIELD OF THE INVENTION

The present invention relates to the use of fine particulate clay materials. preferably those displaying a high weight loss during heat induced dehydroxylation, which are suitable for mixing with a soft magnetic powder material and, optionally, other materials such as lubricants or sendust or other alloys, such as FeSi. The resulting soft magnetic composite powder is useful for the preparation of soft magnetic components, such as dust cores. The invention also relates to the soft magnetic components which are obtained by using this soft magnetic composite powder.

### BACKGROUND OF THE INVENTION

Soft magnetic materials are used for various applications, such as core materials in inductors, stators and rotors for electrical machines, actuators, sensors and transformer cores. Traditionally, soft magnetic cores, such as rotors and stators in electric machines, are made of stacked steel laminates. Soft magnetic composites may also be manufactured from soft magnetic particles, usually iron-based, with an electrically insulating coating on each particle. By compacting the insulated particles, optionally together with lubricants and/or binders, using traditional powder metallurgy process, soft magnetic components, such as dust cores, are obtained. By using powder metallurgy techniques it is possible to produce such components with a higher degree of freedom in design than is possible by using steel laminates, as the components can carry a three dimensional magnetic flux and as three-dimensional shapes can be obtained by the compaction process. It has been shown that such components have good magnetic characteristics, such as core loss or resistivity.

In the search for ways of improving the resistivity different methods have been used and proposed. One method is based on applying electrically insulating coatings or films on the powder particles before these particles are subjected to compaction. Thus there are a large number of publications describing different types of electrically insulating coatings, e.g. U.S. Pat. No. 6,309,748, and U.S. Pat. No. 6,562,458. EP1246209B1 describes a ferromagnetic metal based powder wherein the surface of the metal-based powder is coated with a layer consisting of silicone resin and fine particles of clay minerals having layered structure such as bentonite or talc. JP2002170707A describes an alloyed iron particle coated with a phosphorous containing layer, wherein the alloying elements may be silicon, nickel or aluminium. In a second step the coated powder is mixed with a water solution of sodium silicate followed by drying, wherein the dust cores are produced by moulding the powder, followed by heat treatment of the moulded part in a temperature of 500-1000° C. JP51-089198 discloses the use of sodium silicate as a binding agent for iron powder particles when producing dust cores by moulding of iron powder, followed by heat treatment of the moulded part.

In order to obtain high performance soft magnetic composite components, it is desirable to be able to subject the electrically insulated powder to compression moulding at high pressures as it is often desired to obtain parts having high density. High densities normally improve the magnetic properties. Specifically, high densities are needed in order to keep the hysteresis losses at a low level and to obtain high saturation flux density. Additionally, the electrical insulation must withstand the compaction pressures needed without being damaged when the compacted part is ejected from the die. This in turn means that the ejection forces must not be too high.

For powder cores which are primarily intended for use at higher frequencies, i.e. frequencies above 2 kHz and particularly between 5 and 100 kHz, higher resistivity and lower core losses are essential. Preferably, the saturation flux density shall be high enough to enable core downsizing. Additionally, it should be possible to produce the cores without having to compact the metal powder using die wall lubrication and/or elevated temperatures. Preferably, these steps should be eliminated.

Even though the magnetic properties of components made by iron powder are acceptable, for some applications, there is a need to increase the mechanical strength of the components.

### SUMMARY OF THE INVENTION

According to a first aspect, the present invention relates to a composite iron-based powder mixture comprising iron particles coated with: 1) a first layer which is a phosphorous containing layer; and 2) a second layer which contains an alkaline silicate combined with a clay mineral, wherein the clay contains a phyllosilicate, and wherein the clay is particulate with a particle size (D₅₀) of 0.1-0.4 μm as measured by analytical centrifuge analysis.

The inventors have shown that by using an iron-based powder which is coated by a clay displaying a small particle size in accordance with the present invention, for manufacturing magnetic components such as inductors of electric machines, the mechanical strength of such components is improved.

The present invention relates to an iron-based soft magnetic composite powder, the core particles thereof being coated with a coating rendering the material properties suitable for production of inductors through compaction of the powder followed by a heat treating process.

According to a second aspect, the present invention relates to a soft magnetic component which comprises the composite iron-based powder mixture according to the first aspect of the invention.

The soft magnetic component is preferably an inductor core. The present invention advantageously provides inductor cores which have acceptable magnetic properties, such as low core losses and high saturation flux density, and good mechanical strength.

In addition, according to a third aspect, the present invention relates to the use of said iron-based soft magnetic composite powder, for the production of inductors through compaction of the composite powder, followed by a heat treating process.

The present invention also provides a method for producing such inductor cores, as set out below.

At least one of the objects of the invention is accomplished by the coated iron-based powder according to the present invention. The iron-based powder has a coating comprising a phosphorous layer, i.e. the first layer, and a layer of water glass, also known as alkaline silicate, combined with clay i.e. the second layer.

The phosphorous coating i.e. the first layer, is usually the layer which is closest to the iron core. The iron-based powder particles, thus coated, are mixed with at least one type of clay as part of the second layer. Said clay is constituted by (or in other words consists of), particles having a mean particle size of 0.1 μm to 0.4 μm. In a preferred embodiment, the clay displays a weight loss during heat induced dehydroxylation of above 12 wt %.

The mixing of coated iron-based powder, coated with the first layer containing phosphorous and second layer containing water glass and clay, results in a composite iron-based powder, wherein the clay particles adhere to the surface of the iron-based powder particles. Specifically, the water glass can be added after the addition and mixing of iron based powder with clay.

The iron-based powder particles may contain other alloying elements, such as Si, P, or Ni, and is soft magnetic.

According to a fourth aspect, the present invention also provides a method for producing a sintered magnetic component comprising the steps of:
a) providing a coated iron-based powder according to the first aspect of the invention;
b) compacting the coated iron powder, optionally mixed with a lubricant, optionally in a uniaxial press movement in a die at a compaction pressure between 400 and 1200 MPa;
c) ejecting the compacted component from the die; and
d) heat treating the ejected component, preferably at a temperature up to 700° C., more preferably at 500 to 690° C.

Furthermore, according to a fifth aspect, the present invention provides a component, such as an inductor, produced according to the method of the fourth aspect of the invention.

### BRIEF DESCRIPTION OF FIGURES

Embodiments of the invention will now be described, by way of example, with reference to exemplifying embodiments, experiments and to the accompanying figures, wherein:

FIG. 1 is a diagram showing the effect of relative mass decrease during dehydroxylation of the clay on relative transverse rupture strength (TRS). The %-TRS increase compares the TRS of green bodies with the TRS of sintered bodies.

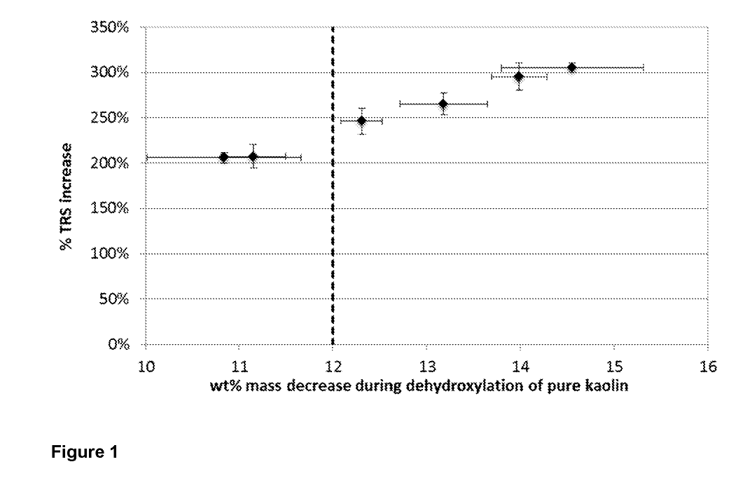

FIG. 2 is a diagram showing the effect of clay particle size on relative transverse rupture strength.

FIG. 3 is a diagram showing the effect of different amounts of two clay samples, one having fine particles and a high weight loss during dehydroxylation and the other having coarse particles and a low weight loss, on transverse rupture strength.

### DETAILED DESCRIPTION OF THE INVENTION

As used herein, the term “powder” is defined as a dry, bulk solid composed of a large number of fine particles that may flow freely when shaken or tilted.

As used herein, the term “iron-based powder” is defined as a powder, the particles of which comprise at least 99 wt % of iron.

The iron-based powder may be a pure iron powder, the particles of which having a low content of contaminants such as carbon or oxygen. The iron content of the particles is preferably above 99.0% by weight, however it may also be possible to utilise iron-based powder alloyed with e.g. silicon, phosphorus, or nickel. For a pure iron-based powder, or for an iron-based powder, the particles of which being alloyed with intentionally added alloying elements, the powders contain besides iron and possible present alloying elements, trace elements resulting from inevitable impurities caused by the method of production. Trace elements are present in such a small amount that they do not influence the properties of the material.

The choice of particle size of the iron-based powder is determined by the intended use, i.e. which frequency the component is suited for. The mean particle size of the iron-based powder, which is also roughly the mean size of the coated powder as the coating is very thin, may be between 20 to 300 μm. Examples of mean particle sizes for suitable iron-based powders are e.g. 20-80 μm, a so called 200 mesh powder, 70-130 μm, a 100 mesh powder, or 130-250 μm, a 40 mesh powder. The method used for determining the particle size is by laser diffractometry according to standard ISO 13320-1:1999.

The iron-based particles are coated by a phosphorous containing coating in addition to the clay coating. The phosphorous containing coating is the first layer. The phosphorous containing coating, which is normally applied to the bare iron-based powder, may be applied according to the methods described in U.S. Pat. No. 6,348,265.

Briefly, the iron or iron-based powder is mixed with phosphoric acid dissolved in a solvent such as acetone, followed by drying in order to obtain a thin phosphorous and oxygen containing coating on the powder. The amount of added solution depends inter alia on the particle size of the powder; however, the amount shall preferably be sufficient in order to obtain a coating having a thickness between 20 and 300 nm. The concentration of the phosphoric acid should be between 1 and 5% and may be sprayed onto the iron particles, or mixed in batch, using a phosphoric acid solution as above.

Alternatively, it is possible to add a thin phosphorous containing coating by mixing an iron-based powder with a solution of ammonium phosphate dissolved in water or using other combinations of phosphorous containing substances and other solvents.

The resulting phosphorous containing coating i.e. the first layer, preferably makes up only a small proportion of the weight of the coated iron-based powder. In particular, the phosphorus containing coating preferably accounts for between 0.01 and 0.15% of the total weight of the iron based powder according to the present invention (i.e. with both first and second layers).

The clay layer is applied to the iron particles by mixing the powder particles with a clay according to the invention.

In more detail, the second layer comprising the alkaline silicate and clay coating is applied after the first layer has been applied, i.e. to the phosphorous coated iron-based powder. The second layer can be applied by mixing the phosphorus coated iron-based powder with particles of a clay or a mixture of clays having the claimed small particle size and a water soluble alkaline silicate, commonly known as water glass. This is usually followed by a drying step at a temperature between 20-250° C. or in vacuum.

The clay particles preferably display a high weight loss during heat induced dehydroxylation. The weight loss during heat induced dehydroxylation can be determined by using ThermoGravimetric Analysis (TGA). TGA can be measured using a Jupiter STA 449 F3 from Netzsch Scandinavia (21121 Malmö, Sweden). The procedure of the analysis is as follows; the pure clay sample is weighed (5 mg) and then placed in the sample holder. The sample and reference are heated at a rate of 10° C./min up to 1100° C. in nitrogen gas. The weight of the sample is continuously monitored as the sample is heated. The weight loss in the temperature range 240-730° C. is taken as the weight decrease during dehydroxylation of the clay. For each sample a duplicate measurement is performed.

Preferably, the weight decrease during dehydroxylation is above 12 wt %, more preferably above 13 wt %, or even more preferably above 14 wt %, i.e. the weight loss observed in the 240-750° C. temperature range exceeds 12, 13, or 14 wt %, respectively.

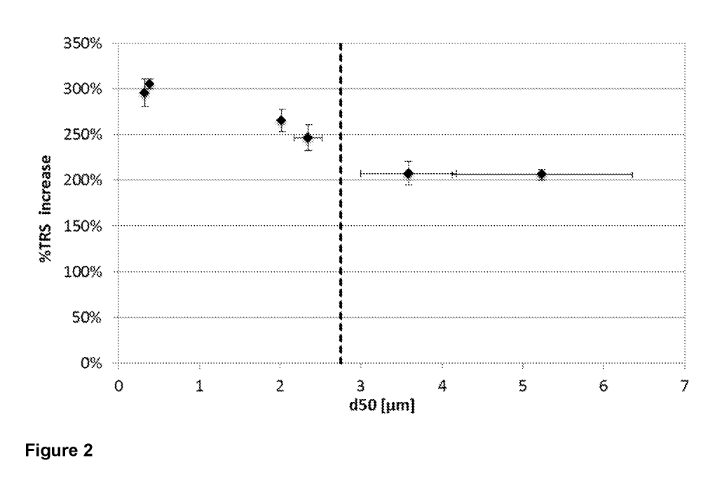

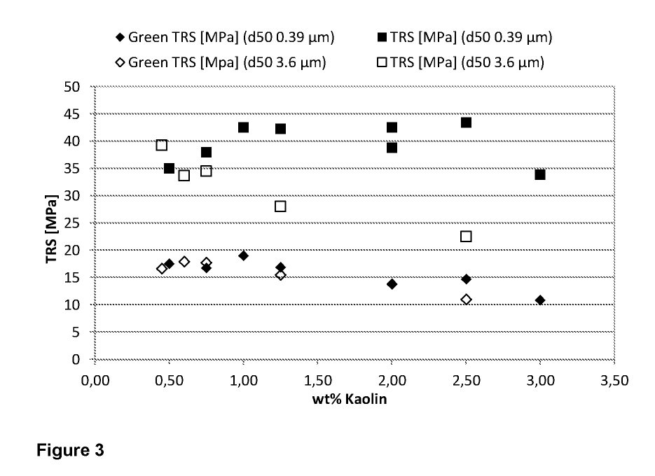

In accordance with the invention, the advantages of the invention are achieved when the clay particles are relatively small, i.e. in the size range of from 0.1 μm to 0.4 μm, or preferably from 0.1 μm to 0.3 μm. Most preferably, the clay particle size is about 0.3 μm. These advantages are clearly shown by the examples, and illustrated in FIGS. 2 and 3, where the samples with a clay particle size according to the invention show improved % TRS increase compared to sample where the particle size of the clay is larger. The other properties are also improved as shown in table 1 in the Examples.

The particle size of the clay particles is determined by analytical centrifuge analysis and are D₅₀ values, i.e. 50% of the particles are smaller than the D₅₀ value. In more detail, the particle size distribution of the clay particles is determined by analytical centrifuge analysis, using a LUMISizer from Teamator (250 23 Helsingborg, Sweden), according to standards ISO13318-1 and ISO13318-2.

All reference to clay mean a clay mineral. Clay minerals are hydrous aluminium phyllosilicates, sometimes with variable proportions to iron, magnesium, alkali metals, alkali metal earth metals, and other cations. The clay of the present invention therefore contains a phyllosilicate. Examples of clays that are suitable for use in the present invention include kaolin, ball clays, fire clays, stoneware clay and earthenware clay. These types of clay are well known to the skilled person. The clay is preferably kaolin. The amount of clay containing defined phyllosilcates to be mixed with the coated iron-based powder shall preferably be between 0.2-5%, preferably between 0.5-4%, by weight of the coated composite iron-based powder.

The amount of alkaline silicate calculated as solid alkaline silicate to be mixed with the phosphorous coated iron-based powder shall preferably be between 0.1-0.9% by weight of the coated composite iron-based powder, preferably between 0.2-0.8% by weight of the coated iron-based powder. It has been shown that various types of water soluble alkaline silicates can be used, thus sodium, potassium and lithium silicate can be used.

### Compaction and Heat Treatment

Before compaction, the coated composite iron-based powder may be mixed with a suitable organic lubricant such as a wax, an oligomer or a polymer, a fatty acid based derivate or combinations thereof. Examples of suitable lubricants are EBS, i.e. ethylene bisstearamide, Kenolube® available from Höganäs AB, Sweden, metal stearates such as zinc stearate or fatty acids or other derivates thereof. The lubricant may be added in an amount of 0.05-1.5% of the total mixture, preferably between 0.1-1.2% by weight. Compaction may be performed at a compaction pressure of 400-1200 MPa at ambient or elevated temperature.

After compaction, the compacted components are subjected to heat treatment at a temperature up to 700° C., preferably between 500-690° C. Examples of suitable atmospheres at heat treatment are inert atmosphere such as nitrogen or argon or oxidizing atmospheres such as air.

All percentages herein are based on weight.

### EXAMPLES

The following examples are intended to illustrate particular embodiments and not to limit the scope of the invention.

### Example 1

The particle size distribution of the clay particles was determined by analytical centrifuge analysis, using a LUMISizer from Teamator (250 23 Helsingborg, Sweden), according to standards ISO13318-1 and ISO13318-2. Samples were dispersed in a 20 mM NaCl solution to a final concentration of 0.2 wt % or 0.4 wt % to reach an initial transmission of about 30%. For each sample a duplicate measurement was performed. Measurement was performed at +7° C. with a speed ramp from 300 rpm to 4000 rpm. Particle sizes were as shown in

TABLE 1
The samples in Table 1 contained 2% clay, and 0.6% water glass.

| | Kaolin clay properties | | Component properties | | | | | |
|---|---|---|---|---|---|---|---|---|
| | Relative mass | Particle | | | Relative | | Core loss@ | Core |
| | decrease due to | size, | Green | | TRS | Ring | 0.05T and | loss@ 0.1T |
| | dehydroxylation | d50 | TRS | TRS | increase | Resistivity | 20 kHz | and 20 kHz |
| Sample | [wt %] | [μm] | [MPa] | [MPa] | [%] | [μOhm * m] | [W/kg] | [W/kg] |
| A comp. | 10.8 | 5.24 | 11 | 22 | 206% | 1400000 | 15.6 | 59.0 |
| B comp. | 11.2 | 3.59 | 12 | 25 | 207% | 412500 | 15.4 | 58.6 |
| C comp. | 12.3 | 2.35 | 12 | 29 | 246% | 315000 | 15.2 | 57.1 |
| D comp. | 13.2 | 2.02 | 12 | 31 | 265% | 201786 | 15.0 | 55.9 |
| E inv. | 14.0 | 0.33 | 13 | 38 | 295% | 439583 | 15.1 | 55.2 |
| F inv. | 14.6 | 0.39 | 14 | 42 | 305% | 340000 | 15.0 | 55.5 |

### Example 2

The thermal characteristics of the clay samples were determined by TGA, using a Jupiter STA 449 F3 from Netzsch Scandinavia (21121 Malmö, Sweden). The procedure of the analysis was as follows; the pure clay sample was weighed (5 mg) and then placed in the sample holder. The sample and reference was heated a rate of 10° C./min up to 1100° C. in nitrogen gas. The weight of the sample was continuously monitored as the sample was heated. The weight loss in the temperature range 240-730° C. was taken as the weight decrease during dehydroxylation of the clay. For each sample a duplicate measurement was performed. The relative weight decrease due to dehydroxylation is listed in Table 1.

### Example 3

Samples of 1 kg of the powder ASM200100.30, a water atomized iron powder which has an iron content above 99.5% by weight, and which is commercially available from Höganäs Aft Sweden, were used. The powder particles were treated with a phosphorous containing solution according to WO2008/069749. Briefly, the coating solution was prepared by dissolving 20 ml of 85% weight of phosphoric acid in 1 000 ml of acetone, and 30 ml of acetone solution was used per 1000 gram of powder. After mixing the phosphoric acid solution with the metal powder, the mixture was allowed to dry. A chemical analysis of the samples disclosed that the oxygen content of the powder obtained by using the aqueous solution was above 0.2% higher than in the base powder, whereas the oxygen content of the powder obtained by using the process according to the invention had an oxygen content less then 0.2% higher then that of the base powder. An AES analysis of the samples showed an oxide thickness below 100 nm for all the samples.

The mean particle size of the iron-powder was about 45 μm as determined by laser diffractometry as in ISO 13320-1. The iron-powder was treated with a phosphorous containing solution according to U.S. Pat. No. 6,348,265, and water glass at an amount of 0.6% by weight. The obtained dry phosphorous coated iron powder was further mixed with a clay according to the invention, or comparative examples, in varying amounts according to table 1. After drying at 120° C. for 1 hour in order to obtain a dry powder, the powder was mixed with 0.6% Kenolube® and compacted at 800 MPa into rings with an inner diameter of 45 mm, an outer diameter of 55 mm and a height of 5 mm. The compacted components were thereafter subjected to a heat treatment process at 530° C. or at 650° C. in a nitrogen atmosphere for 0.5 hours.

### Example 4

The transverse rupture strength (TRS) of the sintered components was assessed according to the ISO 3325:1996 standard. A 6 mm thick test piece resting on two supports was broken by the application of a load at the midpoint between the supports under short-term static loading conditions. The TRS values were as shown in Table 1.

### Example 5

The resulting samples from Example 3 were compacted at 800 MPa or 1100 MPa into rings with an inner diameter of 45 mm, an outer diameter of 55 mm and a height of 5 mm. The compacted components were thereafter subjected to a heat treatment process at 650° C. in a nitrogen atmosphere for 30 minutes. Results are shown in Table 1.

### Example 6

The specific resistivities of the obtained samples were measured by a four point measurement. For maximum permeability, μₘₐₓ, and coercivity measurements the rings were “wired” with 100 turns for the primary circuit and 100 turns for the secondary circuit enabling measurements of magnetic properties with the aid of a hysteresisgraph, Brockhaus MPG 200. For core loss the rings were “wired” with 100 turns for the primary circuit and 30 turns for the secondary circuit with the aid of Walker Scientific Inc. AMH-401POD instrument. Coercivity was shown to be acceptable.

1. A composite iron-based powder mixture comprising iron particles coated with:
1) a first layer which is a phosphorous containing layer; and
2) a second layer which contains an alkaline silicate combined with a clay,
wherein the clay contains a phyllosilicate, and wherein the clay is particulate with a particle size (D₅₀) of 0.1-0.4 μm as measured by analytical centrifuge analysis.

2. Composite iron-based powder mixture according to claim 1, wherein the content of clay is between 0.2-5% by weight of the composite iron-based powder.

3. Composite iron-based powder mixture according to claim 1, wherein the clay is kaolin.

4. Composite iron-based powder mixture according to claim 1, wherein the clay comprises particles which have a particle size (D₅₀) of 0.1-0.3 μm as measured by analytical centrifuge analysis.

5. Composite iron-based powder mixture according to claim 1, wherein the clay has a weight loss upon heat induced dehydroxylation above 12 wt %, as measured by TGA.

6. A soft magnetic component which comprises the composite iron-based powder mixture according to claim 1.

7. The soft magnetic component according to claim 6 which is an inductor core.

8. The soft magnetic component according to claim 7, wherein the inductor core has acceptable magnetic properties.

9. The soft magnetic component according to claim 7, wherein the inductor core has good mechanical strength.

10. A method for the production of inductors, the method comprising:
compacting the composite iron-based powder mixture according to claim 1, and
followed by conducting a heat treating process.

11. A method for producing a sintered magnetic component comprising the steps of:
a) providing a coated iron-based powder according to claim 1;
b) compacting the coated iron-based powder;
c) ejecting the compacted component from the die;
d) heat treating the ejected component.

12. A method according to claim 11, wherein in step b) the coated iron-based powder is mixed with a lubricant before compaction, and/or wherein it is compacted in a uniaxial press movement in a die at a compaction pressure between 400 and 1200 MPa.

13. A method according to claim 11, wherein in step e) the heat treatment is at a temperature up to 700° C.

14. A component produced by the method according to claim 11.
